(19) United States
(12) Patent Application Publication
(10) Pub. No.: US 2023/0133492 A1
(43) Pub. Date: May 4, 2023

(54) IRON SULFIDE AND HYDROGEN SULFIDE TREATMENT FLUID

(71) Applicant: Halliburton Energy Services, Inc., Houston, TX (US)

(72) Inventors: Yulia Mosina, Houston, TX (US); Zhiwei Yue, Houston, TX (US)

(73) Assignee: Halliburton Energy Services, Inc., Houston, TX (US)

(21) Appl. No.: 17/453,250

(22) Filed: Nov. 2, 2021

(51) Int. Cl. C09K 8/532

(52) U.S. Cl. CPC C09K 8/532; C09K 2208/20

(57) ABSTRACT

A treatment fluid for treating iron sulfide and hydrogen sulfide can include a first additive of acrolein that provides a dual function to dissolve iron compounds and scavenge hydrogen sulfide. After dissolution of the iron compounds, free iron is formed, which can react to form iron oxide. The iron oxide can reprecipitate out of the solution. The treatment fluid can also include a second additive that is a chelating agent to chelate the free iron formed. The chelating agent can be a sugar acid. The two additives are compatible with each other and provide a synergistic effect with improved performance compared to the use of either additive alone.

### TECHNICAL FIELD

Iron sulfide and hydrogen sulfide can be present in wellbore environments. A fluid can be used treat iron sulfide and hydrogen sulfide and prevent reprecipitation of iron compounds after treating iron sulfide.

### BRIEF DESCRIPTION OF THE FIGURES

The patent or application file contains at least one drawing executed in color. Copies of this patent or patent application publication with color drawing(s) will be provided by the Office upon request and payment of the necessary fee.

The features and advantages of certain embodiments will be more readily appreciated when considered in conjunction with the accompanying figures. The figures are not to be construed as limiting any of the preferred embodiments.

FIG. 1 is a graph showing compatibility of an iron sulfide treatment compound and two different chelating agents at a concentration of 10,000 parts per million (ppm).

FIG. 2 is a graph showing compatibility of the iron sulfide treatment compound and the two different chelating agents at a concentration of 100 ppm.

FIGS. 3 (1-18) are photographs of a several liquids having various compositions of an iron sulfide treatment compound and different chelating agents at 4 minutes after mixing.

FIG. 4 (1-18) are photographs of the liquids of FIG. 3 at 17 hours after mixing.

FIGS. 5-7 (A-I) are photographs of a several liquids having various compositions of an iron sulfide treatment compound and different chelating agents under anaerobic conditions at an initial mixing time, 24-hour contact time, and 3-day contact time, respectively.

### DETAILED DESCRIPTION

Oil and gas hydrocarbons are naturally occurring in some subterranean formations. In the oil and gas industry, a subterranean formation containing oil and/or gas is referred to as a reservoir. A reservoir can be located under land or offshore. Reservoirs are typically located in the range of a few hundred feet (shallow reservoirs) to a few tens of thousands of feet (ultra-deep reservoirs). In order to produce oil or gas, a wellbore is drilled into a reservoir or adjacent to a reservoir. The oil, gas, or water produced from a reservoir is called a reservoir fluid.

As used herein, a “fluid” is a substance having a continuous phase that can flow and conform to the outline of its container when the substance is tested at a temperature of 71° F. (22° C.) and at a pressure of one atmosphere “atm” (0.1 megapascals “MPa”). A fluid can be a liquid or gas. A homogenous fluid has only one phase; whereas a heterogeneous fluid has more than one distinct phase. A colloid is an example of a heterogeneous fluid. A heterogeneous fluid can be a slurry, which includes a continuous liquid phase and undissolved solid particles as the dispersed phase; an emulsion, which includes a continuous liquid phase and at least one dispersed phase of immiscible liquid droplets; a foam, which includes a continuous liquid phase and a gas as the dispersed phase; or a mist, which includes a continuous gas phase and liquid droplets as the dispersed phase. As used herein, the term “base fluid” means the solvent of a solution or the continuous phase of a heterogeneous fluid and is the liquid that is in the greatest percentage by volume of a treatment fluid.

A well can include, without limitation, an oil-, gas-, or water-production well, an injection well, or a geothermal well. As used herein, a “well” includes at least one wellbore. A wellbore can include vertical, inclined, and horizontal portions, and it can be straight, curved, or branched. As used herein, the term “wellbore” includes any cased, and any uncased, open-hole portion of the wellbore. A near-wellbore region is the subterranean material and rock of the subterranean formation surrounding the wellbore. As used herein, a “well” also includes the near-wellbore region. The near-wellbore region is generally considered to be the region within approximately 100 feet radially of the wellbore. As used herein, “into a subterranean formation” means and includes into any portion of the well, including into the wellbore, into the near-wellbore region via the wellbore, or into the subterranean formation via the wellbore.

A portion of a wellbore can be an open hole or cased hole. In an open-hole wellbore portion, a tubing string can be placed into the wellbore. The tubing string allows fluids to be introduced into or flowed from a remote portion of the wellbore. In a cased-hole wellbore portion, a casing is placed into the wellbore that can also contain a tubing string. A wellbore can contain an annulus. Examples of an annulus include, but are not limited to, the space between the wellbore and the outside of a tubing string in an open-hole wellbore; the space between the wellbore and the outside of a casing in a cased-hole wellbore; and the space between the inside of a casing and the outside of a tubing string in a cased-hole wellbore.

Treatment fluids used in the oil and gas industry commonly include additives and other ingredients used to perform a particular treatment operation within the wellbore or subterranean formation. Such treatment operations can include a fracturing operation, drilling operation, or workover operation. The term “treatment fluid” refers to the specific composition of the fluid as it is being introduced into a subterranean formation. The word “treatment” in the term “treatment fluid” does not necessarily imply any particular action by the fluid. A wellbore environment can naturally include compounds or compounds can be produced that are detrimental to the wellbore and equipment.

For example, iron sulfide and iron oxide compounds have been known to cause several operational problems in the oil and gas industry as well as other industries. The presence of iron-insoluble scale particles in a wellbore can cause loss of injectivity of water in water-injection wells and water-disposal wells. Accumulation of iron sulfide and biomass compounds around downhole screens and perforations can cause a decrease in production of oil, water, or gas. Buildup of iron-sulfide scale in the tubing string can create problems during wireline work and can reduce well deliverability. The presence of iron oxide can cause corrosion issues. The presence of fine particles of iron-insoluble scales in produced crude oil can cause many operational problems in oil-gas separation plants.

The insoluble iron deposits can be removed mechanically or with an acid, or other chemical treatment programs may be used to dissolve the scales. However, acid treatments can create additional risks—especially in high-temperature wells due to corrosivity issues and generation of toxic hydrogen sulfide (H₂S) gas during application. For example, some microorganisms present in wellbore fluids can produce H₂S gas as a respiration end product, which accumulates extracellularly during consumption. It is undesirable for a well to contain high amounts of a sour gas, such as H₂S gas. A well containing greater than 5 parts per million (ppm) of a sour gas is commonly called a sour gas well, while a well containing less than 5 ppm of a sour gas is commonly called a sweet well. Sour gas is considered to be a corrosive substance, which can be detrimental to wellbore operations; for example, harmful to wellbore equipment, such as pumping equipment or pipes. Thus, it is desirable to treat or scavenge H₂S gas when present in sour gas wells.

When dissolving iron sulfide and scavenging H₂S gas with a chemical treatment, free iron (e.g., Fe²⁺ and Fe³⁺) is left in the solution, which can also create problems during a fracturing operation. Fracturing fluids generally contain dissolved and entrained oxygen due to blending operations and the viscosity of the fracturing fluids, which make the fracturing fluids incompatible with formation waters that contain ferrous ion (Fe²⁺). The fracturing fluid mixes with the formation water. The dissolved and entrained oxygen in the fracturing fluid immediately oxidizes the ferrous ion (Fe²⁺) to ferric ion (Fe³⁺), which is less water soluble and more toxic to scale inhibitors, which can significantly decrease the performance of scale inhibitors even at low ferric iron concentrations. This process can also occur in water treatment facilities such as saltwater disposal facilities in addition to the oil and gas industry.

If the wellbore treatment fluid does not contain an effective iron-control system, then the dissolved iron can precipitate out of solution. This precipitate may then accumulate as it is carried toward the wellbore during flowback. The accumulation of iron solids can plug naturally occurring or artificially created fractures or fissures, thus reducing permeability, and can have a detrimental effect on the recovery of the treatment fluid and production.

Several methods have been used to try and control iron reprecipitation in sweet wells. Some of the methods include the use of buffering agents to hold the pH of the fluid below 2.5; chelating agents to react with the ferric ion to provide soluble complexes; reducing agents to modify the oxidation state of ferric ion; and combinations of these methods. However, these methods can have some or all of the aforementioned disadvantages. Moreover, methods that attempt to combat iron reprecipitation and H₂S gas have involved multi-stage treatment operations that can be time consuming, more costly, and oftentimes not as effective as needed.

It is critical to identify a way of controlling iron reprecipitation in wells, including sour-gas wells, that simultaneously scavenges hydrogen sulfide. It has been discovered that a fluid can include a first additive that dissolves iron compounds and is an H₂S scavenger by reacting with iron to form a soluble, stable product for preventing deposition of iron oxide, iron sulfide, or other iron insoluble forms and a second additive that chelates free iron or iron oxide in the fluid to prevent reprecipitation. It was unexpectedly discovered that the second additive is compatible and stable with the first additive. The first and second additives obtained a synergistic effect whereby the second additive increased the rate of iron compound dissolution and required a lower concentration of the first additive compared to a fluid containing only the first additive.

A treatment fluid can include a base fluid; a first additive, wherein the first additive dissolves an iron compound to form free iron in the treatment fluid, and wherein the first additive scavenges hydrogen sulfide gas; and a second additive, wherein the second additive chelates the free iron, wherein the first additive and the second additive are compatible and create a synergistic effect.

A method of treating a portion of a subterranean formation can also include introducing the treatment fluid into the subterranean formation.

The various disclosed embodiments can apply to the treatment fluid and method embodiments. As used herein, any reference to the unit “gallons” means U.S. gallons.

The treatment fluid can be a solution, a colloid, an emulsion, or an invert emulsion. The treatment fluid includes a base fluid. The base fluid can include dissolved materials or undissolved solids. The base fluid can include a hydrocarbon liquid or an internal phase of the treatment fluid can include a hydrocarbon liquid. The hydrocarbon liquid can be selected from the group consisting of a fractional distillate of crude oil; a fatty derivative of an acid, an ester, an ether, an alcohol, an amine, an amide, or an imide; a saturated hydrocarbon; an unsaturated hydrocarbon; a branched hydrocarbon; a cyclic hydrocarbon; and any combination thereof. Crude oil can be separated into fractional distillates based on the boiling point of the fractions in the crude oil. An example of a fractional distillate of crude oil is diesel oil. The saturated hydrocarbon can be an alkane or paraffin. The paraffin can be an isoalkane (isoparaffin), a linear alkane (paraffin), or a cyclic alkane (cycloparaffin). The unsaturated hydrocarbon can be an alkene, alkyne, or aromatic. The alkene can be an isoalkene, linear alkene, or cyclic alkene. The linear alkene can be a linear alpha olefin or an internal olefin.

The base fluid or an internal phase of the treatment fluid can comprise water. The water can be selected from the group consisting of freshwater, seawater, brine, and any combination thereof in any proportion. The treatment fluid can further include a water-soluble salt. The water-soluble salt can be selected from the group consisting of sodium chloride, calcium chloride, calcium bromide, potassium chloride, potassium bromide, magnesium chloride, and any combination thereof. The treatment fluid can contain the water-soluble salt in a concentration in the range of about 35 to about 90 pounds per barrel (ppb) (348 kilograms per cubic meter “kg/m³”) of the water.

The treatment fluid includes a first additive, wherein the first additive dissolves an iron compound to form free iron in the treatment fluid. The first additive can be an unsaturated aldehyde. The unsaturated aldehyde can be acrolein (IUPAC name prop-2-enal). Acrolein has the chemical formula C₃H₄O. The first additive can dissolve or solubilize a variety of iron compounds. The first additive can dissolve any of the following iron compounds, iron (II) sulfide (FeS), mackinawite (Fe₁₊ₓS, wherein x=0 to 0.11), greigite (Fe₃S₄), troilite (FeS), and pyrrhotite (Fe₁₋ₓS, wherein x=0 to 0.2). Upon dissolution of the iron compound by the first additive, free iron is formed in the treatment fluid. Below is one example of a chemical reaction of iron (II) sulfide and acrolein with free iron as an end product.

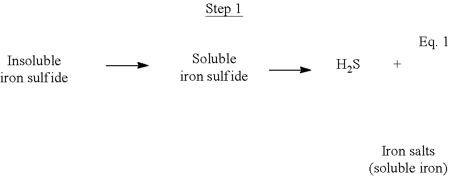

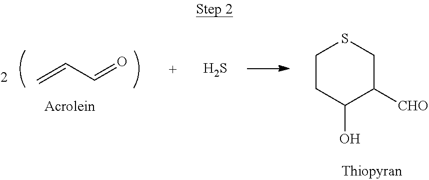

Hydrogen sulfide can cause damage to tubing string or other wellbore equipment by either reacting directly with metals or metal alloys that creates an iron sulfide corrosion film or by increasing the acidity of a liquid/gas mixture in the wellbore. H₂S can also be oxidized to form elemental sulfur when dissolved in water. Elemental sulfur can also produce an iron sulfide corrosion film when in direct contact with a metal surface. The first additive also scavenges H₂S gas. Accordingly, the first additive provides a dual function to dissolve an iron compound and scavenge H₂S gas. A hydrogen sulfide scavenger can chemically react selectively with and remove H₂S from wellbore fluids as shown, for example, in Equation 2 below.

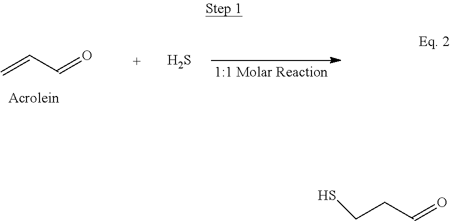

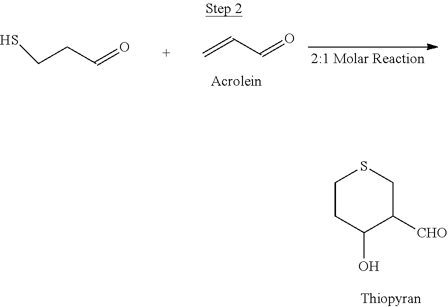

Iron sulfide precipitates are formed when the capacity of a solution to hold ferrous ion and sulfide is exceeded (Eq. 3). Chelating agents can function by removing the free ferrous ion from the solution and forming ferrous chelate compounds (Eq. 4). The free ferrous ion is the reactive iron material in the precipitation of iron sulfide.

Fe²⁺+S²⁻—FeS↓ Eq. 3

Fe²⁺+chelating agent-[Fe complex] Eq. 4

The treatment fluid also includes a second additive. The second additive chelates the free iron product of dissolution of the iron compound with the first additive. Accordingly, the second additive can be a chelating agent. The second additive can form a chelate complex or coordination complex containing one metal oxide and at least one polydentate or monodentate ligand. A chelate complex exists when a single metal ion forms coordinate bonds with a polydentate ligand. A ligand is commonly called a chelant, chelating agent, or sequestering agent. A coordination complex exists when a single metal ion forms coordinate bonds with a monodentate ligand.

The ligand sequesters and inactivates the central metal ion so the metal ion does not easily react with other elements or ions to produce precipitates or scale. A polydentate ligand is a molecule or compound in which at least two atoms of the ligand bond with the metal ion. A polydentate ligand can be, for example, bidentate (2 atoms bond), tridentate (3 atoms bond), tetradentate (4 atoms bond), pentadentate (5 atoms bond), and so on. A monodentate ligand is a molecule or compound in which only one atom of the ligand bonds with the metal ion. The ligand can also contain at least one functional group that is capable of forming a bond with the metal ion (e.g., the free iron).

The second additive can be ethylenediaminetetraacetic acid (EDTA) or hydroxyethylethylenediaminetriacetic acid (HEDTA). The second additive chelating agent can also be a sugar acid. A sugar acid is a monosaccharide containing a carboxyl group at one end or both ends of the monosaccharide chain. The sugar acid can be selected from the group consisting of aldonic acids, uronic acids, aldaric acids, and combinations thereof. Nomenclature of sugar acids is generally based on the sugars from which they are derived.

An aldonic acid is obtained by oxidation of the aldehyde functional group of an aldose to form a carboxylic acid functional group and has a general chemical formula of HOOC—(CHOH)ₙ—CH₂OH. Examples of aldonic acids include, but are not limited to, glyceric acid, xylonic acid, gluconic acid, and ascorbic acid. Oxidation of the terminal hydroxyl group instead of the terminal aldehyde yields a uronic acid, while oxidation of both terminal ends yields an aldaric acid. Uronic acids contain both carbonyl and carboxylic acid functional groups. Examples of uronic acids include, but are not limited to, glucuronic acid, galacturonic acid, and iduronic acid. Aldaric acids contain two carboxylic acid functional groups replacing terminal hydroxyl and carbonyl groups of the monosaccharide. Examples of aldaric acids include, but are not limited to, tartaric acid, meso-galactaric acid (mucic acid), and D-glucaric acid (saccharic acid).

The chelating agent can also include a counter cation. The counter cation can be an alkali metal or an alkaline earth metal. Alkali metals are found in Group 1 and alkaline earth metals are found in Group 2 of the Periodic Table. The counter cation can be selected from the group consisting of sodium, potassium, magnesium, calcium, strontium, cesium, and combinations thereof. There can be more than one type of chelating agent used. For example, a gluconic acid having a sodium counter cation can be used along with a galacturonic acid with a magnesium counter cation.

The first additive and the second additive are compatible and create a synergistic effect. As used herein, the term “compatible” means the second additive does not negatively interact with and decrease the concentration of the first additive. By way of example, some known chelating agents, such as tetrakis(hydroxymethyl)phosphonium sulfate (THPS) and triazine, are not compatible with acrolein and decrease the concentration of acrolein; thus, reducing the amount of acrolein available to perform the dual function. For example, the amount of acrolein available may be sufficient to dissolve the iron compound, but because of the incompatible chelating agent, there may not be a sufficient amount of acrolein available to scavenge H₂S. Moreover, the concentration of the second additive chelating agent may determine compatibility between the first and second additives. By way of example, compatibility may only be achieved when the second additive is in a specific concentration range that is critical for providing compatibility.

Acrolein is considered a very reactive compound and toxic. Therefore, acrolein is generally used in a treatment fluid by itself and other compounds are not compatible. Accordingly, most treatment operations involved a multi-stage process in which different fluids were used at different times. Also, it was thought that no chelating agents would be compatible with acrolein. It was unexpectedly discovered that a sugar acid as the chelating agent is compatible with acrolein at concentrations that are economically feasible.

The first and second additives also create a synergistic effect. Using acrolein alone requires a higher concentration of acrolein and dissolution of the iron compound occurs much slower than with the addition of the second additive. The second additive chelating agent chelates the free iron formed, thereby allowing the reaction of acrolein and the iron compound and hydrogen sulfide to proceed much faster. This synergistic effect was also unexpectedly discovered.

The first additive can be in a concentration in the range of 0.001% to 10% volume by volume (v/v) of the base fluid or 100 to 100,000 ppm of the base fluid. The second additive can be in a concentration in the range of 0.006% to 30% v/v of the base fluid or 60 to 100,000 ppm of the base fluid. The concentration of the second additive is critical to being compatible with the first additive. According to any of the embodiments, the concentration of the second additive is selected such that the second additive is compatible with the first additive. The concentration of the second additive can also be selected based on the water solubility limit of the second additive.

The treatment fluid can also include one or more additional additives. The treatment fluid can include an organic acid. The organic acid can increase the activity and extend the half-life of the first additive. The organic acid can be, for example, acetic acid.

The treatment fluid can be a drilling fluid, workover fluid, spacer fluid, or stimulation fluid, such as a fracturing or acidizing fluid. The one or more additional additives can be selected based on the type of treatment fluid and can be selected from, without limitation, a surfactant, an emulsifier, a viscosifier, a viscosity reducing agent or thinner, an emulsion breaker, a weighting agent, a fluid loss additive, a friction reducer, a lost-circulation material, proppant, or combinations thereof.

The methods include introducing the treatment fluid into a subterranean formation. The subterranean formation can be penetrated by a wellbore. The methods can include introducing the treatment fluid into a portion of the wellbore. The treatment fluid can intermix with other fluids located within the wellbore and come in contact with tubing and casing strings and wellbore equipment. According to any of the embodiments, the treatment fluid remains in the portion of the wellbore for a desired period of time. The desired period of time can be a minimum amount of time such that the iron compound, such as iron sulfide, is dissolved, hydrogen sulfide is scavenged, and free iron is prevented from forming a compound and reprecipitating out of the treatment fluid. The desired period of time can be in the range of 6 hours to 5 days or 24 hours to 72 hours. The desired period of time can be less than the period of time if using acrolein alone. By way of example, it is not uncommon for it to take up to 17 days for acrolein alone to dissolve iron compounds. This demonstrates the synergistic effect of the first and second additive.

It is to be understood that while the treatment fluid can contain other ingredients, it is the first and second additives that are primarily or wholly responsible for providing the requisite treatment (i.e., dissolution of the iron compound, hydrogen sulfide scavenging, and chelation of free iron). For example, a test treatment fluid consisting essentially of, or consisting of, the base fluid and the first and second additives and in the same proportions as the treatment fluid can provide the requisite treatment. Therefore, it is not necessary for the treatment fluid to include other additives to provide the requisite treatment. It is also to be understood that any discussion related to a “test treatment fluid” is included for purposes of demonstrating that the treatment fluid can contain other ingredients, but it is the first and second additives that create the requisite treatment. Therefore, while it may not be possible to perform a test in a wellbore for the specific treatment fluid, one can formulate a test treatment fluid to be tested in a laboratory to identify if the ingredients and concentration of the ingredients will provide the requisite treatment. It is also to be understood that that second additive can chelate other metals in addition to free iron, but the second additive is primarily or wholly responsible for chelating the free iron.

Some of the advantages to fluids, reservoirs, and wellbore equipment that the combination of the first and second additives provide include decreasing deposits, scavenging H₂S, controlling bacteria, decreasing corrosion, reducing filter changes, reducing equipment failure, increasing pump run time, eliminating safety concerns due to H₂S, preventing formation damage, increasing production or injectivity, preventing “Gummy Bear” creation downhole during a fracturing operation, and eliminating/minimizing an acid wash after the fracturing operation.

An embodiment of the present disclosure is a method of treating a portion of a subterranean formation comprising: introducing a treatment fluid into the subterranean formation, wherein the treatment fluid comprises: a base fluid; a first additive, wherein the first additive dissolves an iron compound to form free iron in the treatment fluid, and wherein the first additive scavenges hydrogen sulfide gas; and a second additive, wherein the second additive chelates the free iron, wherein the first additive and the second additive are compatible and create a synergistic effect. Optionally, the method further comprises wherein the first additive is an unsaturated aldehyde. Optionally, the method further comprises wherein the unsaturated aldehyde is acrolein. Optionally, the method further comprises wherein the second additive is a chelating agent. Optionally, the method further comprises wherein the second additive is selected from the group consisting of ethylenediaminetetraacetic acid, hydroxyethylethylenediaminetriacetic acid, a sugar acid, and combinations thereof. Optionally, the method further comprises wherein the sugar acid is selected from the group consisting of aldonic acids, uronic acids, aldaric acids, and combinations thereof. Optionally, the method further comprises wherein the aldonic acid is selected from glyceric acid, xylonic acid, gluconic acid, or ascorbic acid. Optionally, the method further comprises wherein the uronic acid is selected from glucuronic acid, galacturonic acid, or iduronic acid. Optionally, the method further comprises wherein the aldaric acid is selected from tartaric acid, meso-galactaric acid, or D-glucaric acid. Optionally, the method further comprises wherein the chelating agent comprises a counter cation, wherein the counter cation is an alkali metal or an alkaline earth metal. Optionally, the method further comprises wherein the counter cation is selected from the group consisting of sodium, potassium, magnesium, calcium, strontium, cesium, and combinations thereof. Optionally, the method further comprises wherein the first additive is in a concentration in the range of 0.001% to 10% volume/volume of the base fluid. Optionally, the method further comprises wherein the first additive is in a concentration in the range of 100 to 100,000 parts per million of the base fluid. Optionally, the method further comprises wherein the second additive is in a concentration in the range of 0.006% to 30% volume/volume of the base fluid. Optionally, the method further comprises wherein the second additive is in a concentration in the range of 60 to 100,000 parts per million of the base fluid. Optionally, the method further comprises wherein the treatment fluid remains in the subterranean formation for a desired period of time, wherein the desired period of time is a minimum amount of time such that the iron compound is dissolved, hydrogen sulfide is scavenged, and the free iron is prevented from forming a compound and reprecipitating out of the treatment fluid. Optionally, the method further comprises wherein the desired period of time is in the range of 6 hours to 5 days.

Another embodiment of the present disclosure is a treatment fluid comprising: a base fluid; a first additive, wherein the first additive dissolves an iron compound to form free iron in the treatment fluid, and wherein the first additive scavenges hydrogen sulfide gas; and a second additive, wherein the second additive chelates the free iron, wherein the first additive and the second additive are compatible and create a synergistic effect. Optionally, the fluid further comprises wherein the first additive is an unsaturated aldehyde. Optionally, the fluid further comprises wherein the unsaturated aldehyde is acrolein. Optionally, the fluid further comprises wherein the second additive is a chelating agent. Optionally, the fluid further comprises wherein the second additive is selected from the group consisting of ethylenediaminetetraacetic acid, hydroxyethylethylenediaminetriacetic acid, a sugar acid, and combinations thereof. Optionally, the fluid further comprises wherein the sugar acid is selected from the group consisting of aldonic acids, uronic acids, aldaric acids, and combinations thereof. Optionally, the fluid further comprises wherein the aldonic acid is selected from glyceric acid, xylonic acid, gluconic acid, or ascorbic acid. Optionally, the fluid further comprises wherein the uronic acid is selected from glucuronic acid, galacturonic acid, or iduronic acid. Optionally, the fluid further comprises wherein the aldaric acid is selected from tartaric acid, meso-galactaric acid, or D-glucaric acid. Optionally, the fluid further comprises wherein the chelating agent comprises a counter cation, wherein the counter cation is an alkali metal or an alkaline earth metal. Optionally, the fluid further comprises wherein the counter cation is selected from the group consisting of sodium, potassium, magnesium, calcium, strontium, cesium, and combinations thereof. Optionally, the fluid further comprises wherein the first additive is in a concentration in the range of 0.001% to 10% volume/volume of the base fluid. Optionally, the fluid further comprises wherein the first additive is in a concentration in the range of 100 to 100,000 parts per million of the base fluid. Optionally, the fluid further comprises wherein the second additive is in a concentration in the range of 0.006% to 30% volume/volume of the base fluid. Optionally, the fluid further comprises wherein the second additive is in a concentration in the range of 60 to 100,000 parts per million of the base fluid. Optionally, the fluid further comprises wherein the treatment fluid remains in a subterranean formation for a desired period of time, wherein the desired period of time is a minimum amount of time such that the iron compound is dissolved, hydrogen sulfide is scavenged, and the free iron is prevented from forming a compound and reprecipitating out of the treatment fluid. Optionally, the fluid further comprises wherein the desired period of time is in the range of 6 hours to 5 days.

### Examples

To facilitate a better understanding of the various embodiments, the following examples are given.

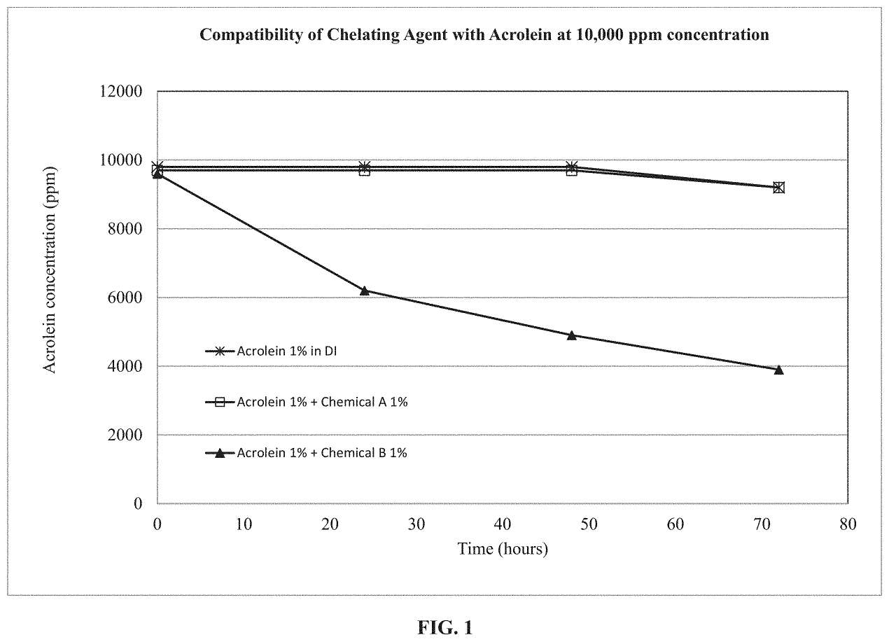

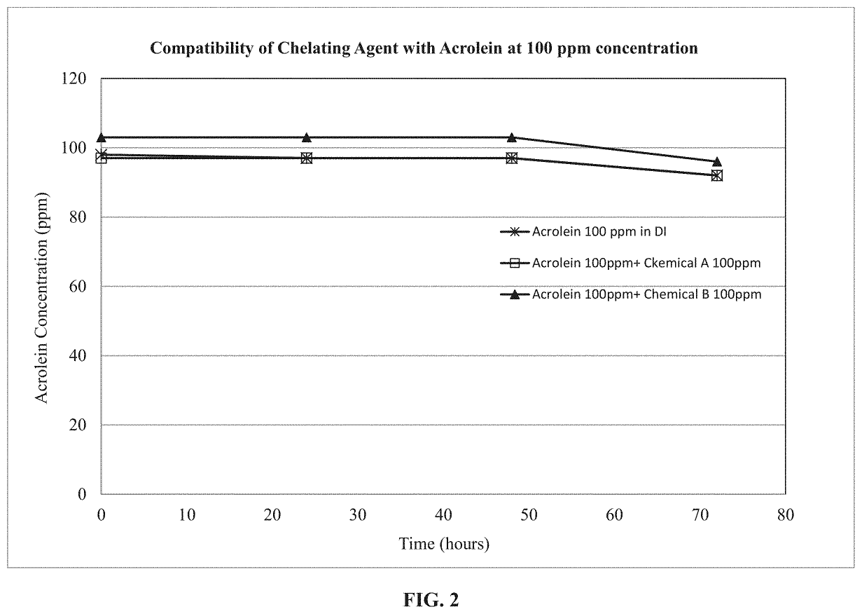

Chemical compatibility tests were performed to test different chelating agents with acrolein using Wilson Analytical Quat Box Fluorescent Spectrometer as follows. Acrolein as the first additive was mixed with deionized (DI) water at a concentration of 1% v/v of the water (10,000 ppm) as a control. Two more fluids were prepared using two different chelating agents of an aldonic acid-based chelating agent (sugar acid) as Chemical A and ethylenediaminetetraacetic acid (EDTA) as Chemical B in the same concentration as the acrolein. The fluids were kept for 4 days at room temperature (˜73° F. (˜23° C.)). The concentration of acrolein in each fluid was measured daily. The same fluid ingredients were used at a concentration of 0.01% v/v of the water (100 ppm) to test different concentrations. The results for the concentration of 10,000 ppm are shown in FIG. 1 and the results for the concentration of 100 ppm are shown in FIG. 2.

As can be seen in FIG. 1, at a concentration of 10,000 ppm, Chemical A of the sugar acid had almost identical concentrations of acrolein compared to the control fluid containing only acrolein. This indicates that the sugar acid is compatible with acrolein at this concentration. By contrast, Chemical B of EDTA showed an acrolein concentration decrease from 10,000 ppm to less than 4,000 ppm. This indicates that at a concentration of 10,000 ppm, the EDTA is not compatible with acrolein. However, as seen in FIG. 2, at a concentration of 100 ppm, both the sugar acid Chemical A and the EDTA Chemical B were compatible with acrolein and the concentration of acrolein did not decrease below the control fluid. This indicates that the concentration of the chelating agent can be selected to provide compatibility with acrolein. Moreover, the results shown in FIGS. 1 and 2 demonstrate the unexpected results that the chelating agents would be compatible with acrolein, which was believed not to be possible.

Next, the efficiency of the additives was tested under aerobic conditions (oxygen was not eliminated) as follows. 1 liter (L) of synthetic brine was prepared, and 500 milliliters (mL) was mixed with 0.1788 g of FeCl₂ and the fluid was placed into a closed vessel. Table 1 shows the composition of the synthetic brine used, where selected ions were added to distilled water.

TABLE 1

| | Concentration |
|---|---|
| Ions | of ion (mg/L) |
| Ca²⁺ | 154.05 |
| Mg²⁺ | 26.38 |
| HCO₃⁻ | 854 |
| SO₄²⁻ | 242 |
| Cl⁻ | 11,000 |
| K⁺ | 21.44 |
| Sr²⁺ | 10.97 |
| Fe²⁺ | 100 |
| Ba²⁺ | 0.32 |

Next, 300 ppm H₂S/N₂ gas was purged through the fluid for creating iron sulfide in the solution. The resulting fluids of “black water” were then aliquoted into several bottles and different concentrations of acrolein and different iron chelating agents were added to the bottles. Chemical A was the aldonic acid (sugar acid) based chelating agent. Chemical B was EDTA. Scavenger C was a hydrogen sulfide scavenger of MEA Triazine. Table 2 lists the concentrations of the additives in units of parts per million.

TABLE 2

| | Acrolein | Chemical A | Chemical B | Scavenger C |
|---|---|---|---|---|
| | concentration | sugar acid | EDTA | MEA Triazine |
| # | (ppm) | (ppm) | (ppm) | (ppm) |
| 1 | 0 | 0 | 0 | 0 |
| 2 | 100 | 0 | 0 | 0 |
| 3 | 200 | 0 | 0 | 0 |
| 4 | 1,000 | 0 | 0 | 0 |
| 5 | 66,700 | 0 | 0 | 0 |
| 6 | 0 | 0 | 333 | 0 |
| 7 | 0 | 0 | 66,700 | 0 |
| 8 | 0 | 333 | 0 | 0 |
| 9 | 0 | 66,700 | 0 | 0 |
| 10 | 0 | 0 | 66,700 | 66,700 |
| 11 | 100 | 0 | 33.3 | 0 |
| 12 | 200 | 0 | 66.67 | 0 |
| 13 | 1,000 | 0 | 333.67 | 0 |
| 14 | 66,700 | 0 | 66,700 | 0 |
| 15 | 100 | 66.67 | | 0 |
| 16 | 200 | 633.33 | 0 | 0 |
| 17 | 1,000 | 666.67 | 0 | 0 |
| 18 | 66,700 | 66,700 | 0 | 0 |

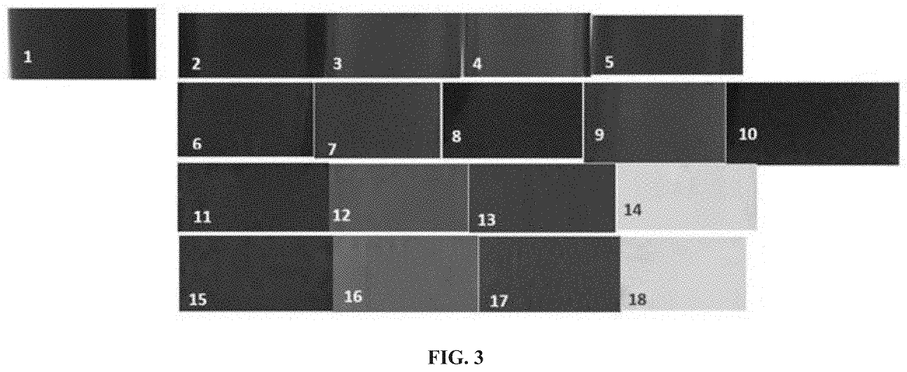

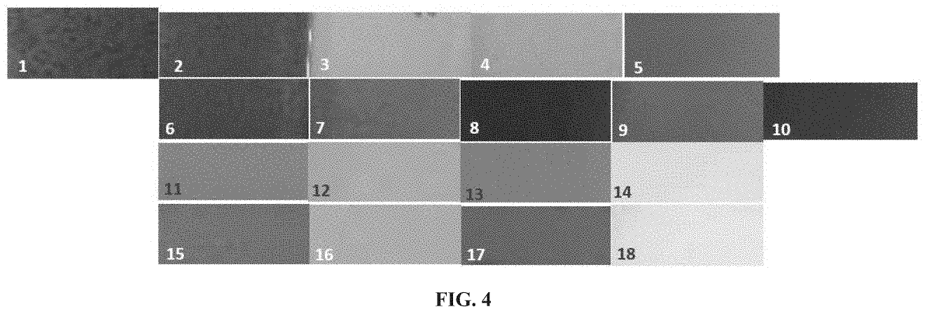

FIG. 3 shows photographs of the synthetic brine fluids (1-18) corresponding to Table 2 at 4 minutes after mixing. FIG. 4 shows photographs of the same fluids 17 hours after mixing. As shown in FIGS. 3 and 4, acrolein only (fluids 2-5) dissolves iron sulfide and reacts with H₂S, producing free iron that further reacted with oxygen to form iron oxide as indicated by the yellowish color. The chelating agents only (fluids 6-9) show that the chelating agents do not dissolve iron sulfide as indicated by the dark grey to black color. A hydrogen sulfide scavenger other than acrolein with EDTA chelating agent (fluid 10) did not show good performance as indicated with a black color with deposits. Acrolein with EDTA Chelator B (fluids 11-14) show a synergistic effect as seen on fluid 14. Acrolein with the sugar acid Chelator A (fluids 15-18) also show a synergistic effect.

100 ppm acrolein alone is not enough for dissolving all iron sulfide (fluid 2), but adding 33.33 ppm of EDTA Chemical B to the acrolein (sample 11) shows that the acrolein does dissolve iron sulfide but was not enough for chelating all the free iron from the solution as evidenced by the brownish color. A more critical observation was that right after adding a high concentration of acrolein (6.67%) with a high concentration of the EDTA chelating agent (6.67%), the solution became clear in less than 4 min (sample 14), which was not observed with just using acrolein alone (fluid 5) or EDTA chelating agent alone (fluid 7) at the same concentration. However, acrolein and the chelating agents (Chemicals A and B) were possibly in too high of a concentration of 66,700 ppm to be economically feasible.

Adding 633 ppm of the sugar acid Chemical A with 200 ppm acrolein (fluid 16) made the fluid clearer. A more critical observation was that right after adding a high concentration of acrolein (6.67%) with a high concentration of the sugar acid chelating agent (6.67%), the solution became clear in less than 4 min (sample 18), which was not observed with just using acrolein alone (fluid 5) or just the sugar acid chelating agent alone (fluid 9) at the same concentration.

As can be seen in FIG. 3, none of the fluids except for fluids 14 and 18 showed any dissolution of the iron compounds nor reprecipitation of iron oxide. However, in FIG. 4 at 17 hours after mixing, several of the fluids exhibited good results. Fluids 1 of the control, 6 and 7 of only EDTA, 8 and 9 of only the sugar acid, and 10 of EDTA and the H₂S scavenger showed no meaningful effect of controlling iron sulfide, iron oxide, and hydrogen sulfide. Fluid 12 containing both acrolein and EDTA at lower concentrations showed comparable results to fluid 4 containing only acrolein. This shows the synergistic effect of the acrolein and an EDTA chelating agent. Moreover, fluid 16 containing both acrolein and the sugar acid showed superior results at low concentrations. This also shows the synergistic effect of the acrolein and the sugar acid chelating agent.

Another set of tests was performed under anaerobic conditions, where nitrogen vials were used instead of bottles. For the test, 1 L of the synthetic brine water was prepared as listed in Table 1 and mixed with 0.1788 g of FeCl₂.4H₂O and the fluid was placed into the closed vessel. Then 300 ppm H₂S/N₂ gas was purged through the fluid for creating iron sulfide in the solution. The dissolved sulfides level was 30 mg/L as measured by Calgon Sulfides kit and the dissolved iron level was 4 mg/L as measured by Hach Iron Kit, and the rest of the iron created iron sulfide in the solution. The “black water” was then aliquoted into nitrogen vials by using sterile syringes for minimizing air. Acrolein and the sugar acid chelating agent (Chemical A) were added in each vial in a variety of concentrations listed below in Table 3.

TABLE 3

| | | Chemical A |
|---|---|---|
| | Acrolein | sugar acid |
| # | (ppm) | (ppm) |
| A | 0 | 0 |
| B | 432 | 0 |
| C | 864 | 0 |
| D | 1,350 | 0 |
| E | 0 | 288 |
| F | 0 | 576 |
| G | 0 | 864 |
| H | 864 | 576 |
| I | 1,350 | 864 |

After 3 days, the solutions were filtered through a 5-micrometer nylon filter and the dissolved iron content was measured in the filtered water. After filtration, all deposits, including iron sulfide, iron oxide, and others, were left on the nylon filters and weighed. The water-soluble chelating complex was kept in the solution, and the total iron level was measured in the solution after filtration by a Hach Iron Kit. The results are listed below in Table 4.

TABLE 4

| | Deposits | Dissolved iron | |
|---|---|---|---|
| # | weight (mg) | level (mg/L) | Observations after 3 days |
| A | 0.1156 | 0 | Became lighter but still has black |
| | | | precipitation (FeS) in solution |
| B | 0.0389 | 1 | Orange color |
| C | 0.0301 | 0 | Dark orange/grey color |
| D | 0.0275 | 0 | Orange color |
| E | 0.1134 | 6 | Became lighter but still has black |
| | | | precipitation (FeS) in solution, like |
| | | | control |
| F | 0.1142 | 0 | Black solution as was prior treatment |
| G | 0.1112 | 6 | Became lighter but still has black |
| | | | precipitation (FeS) in solution, like |
| | | | control |
| H | 0.0102 | 15 | No precipitation in solution, light |
| | | | grey color |
| I | 0.0092 | 20 | No precipitation in solution, light |
| | | | amber color as Synthetic Brine prior |
| | | | purging with H₂S |

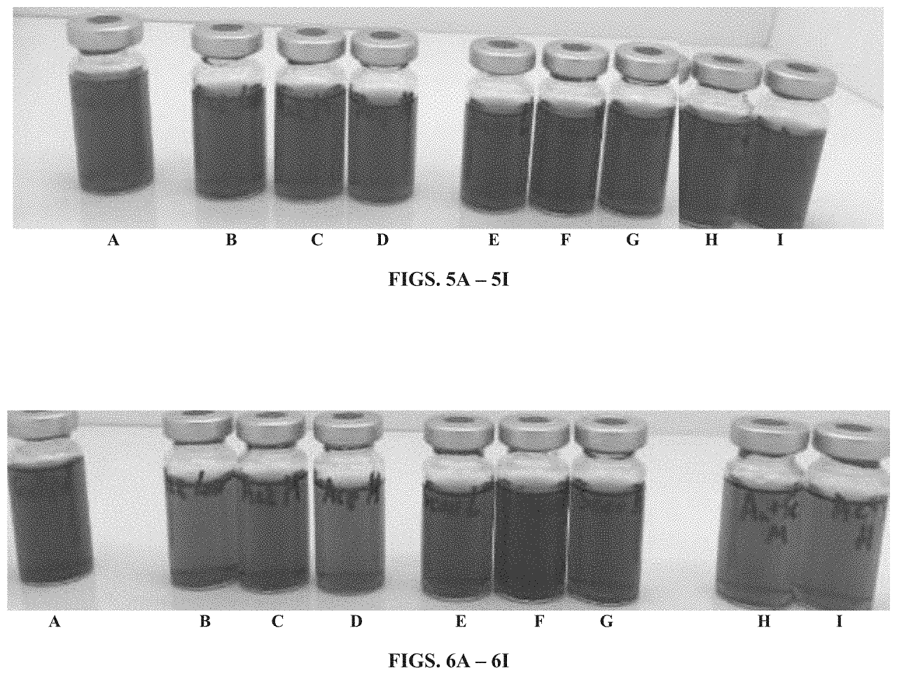

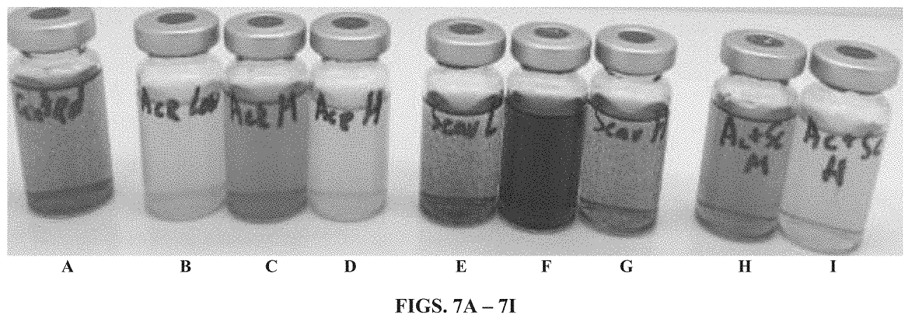

FIG. 5 shows photographs of the vials just after adding the acrolein and/or Chemical A; FIG. 6 shows photographs 24 hours after mixing; and FIG. 7 shows photographs 3 days after mixing. As can be seen in FIGS. 5-7 and Table 4, acrolein and the sugar acid chelating agent show a synergistic effect. By using both in the fluid, the solids decreased more than 90% (fluids H and I). By combining acrolein with the sugar acid at the same concentration, up to a 76% reduction of solids occurred; whereas by using the same amount of the sugar acid chelating agent alone, only a 3.8% solids reduction occurred compared to the control fluid A. Fluid I showed superior results with only 0.0092 mg of solids and 20 mg/L of dissolved iron in the solution. This shows that acrolein and the sugar acid work very well together to dissolve iron compounds and chelate the free iron to prevent reprecipitation of iron oxide.

The exemplary fluids and additives disclosed herein may directly or indirectly affect one or more components or pieces of equipment associated with the preparation, delivery, recapture, recycling, reuse, and/or disposal of the disclosed fluids and additives. For example, the disclosed fluids and additives may directly or indirectly affect one or more mixers, related mixing equipment, mud pits, storage facilities or units, fluid separators, heat exchangers, sensors, gauges, pumps, compressors, and the like used to generate, store, monitor, regulate, and/or recondition the exemplary fluids and additives. The disclosed fluids and additives may also directly or indirectly affect any transport or delivery equipment used to convey the fluids and additives to a well site or downhole, such as, for example, any transport vessels, conduits, pipelines, trucks, tubulars, and/or pipes used to fluidically move the fluids and additives from one location to another, any pumps, compressors, or motors (e.g., topside or downhole) used to drive the fluids and additives into motion, any valves or related joints used to regulate the pressure or flow rate of the fluids, and any sensors (i.e., pressure and temperature), gauges, and/or combinations thereof, and the like. The disclosed fluids and additives may also directly or indirectly affect the various downhole equipment and tools that may come into contact with the fluids and additives such as, but not limited to, drill string, coiled tubing, drill pipe, drill collars, mud motors, downhole motors and/or pumps, floats, MWD/LWD tools and related telemetry equipment, drill bits (including roller cone, PDC, natural diamond, hole openers, reamers, and coring bits), sensors or distributed sensors, downhole heat exchangers, valves and corresponding actuation devices, tool seals, packers and other wellbore isolation devices or components, and the like.

Therefore, the various embodiments are well adapted to attain the ends and advantages mentioned as well as those that are inherent therein. The particular embodiments disclosed above are illustrative only, as the various embodiments may be modified and practiced in different but equivalent manners apparent to those skilled in the art having the benefit of the teachings herein. Furthermore, no limitations are intended to the details of construction or design herein shown, other than as described in the claims below. It is, therefore, evident that the particular illustrative embodiments disclosed above may be altered or modified and all such variations are considered within the scope and spirit of the present invention.

As used herein, the words “comprise,” “have,” “include,” and all grammatical variations thereof are each intended to have an open, non-limiting meaning that does not exclude additional elements or steps. While compositions, systems, and methods are described in terms of “comprising,” “containing,” or “including” various components or steps, the compositions, systems, and methods also can “consist essentially of” or “consist of” the various components and steps. It should also be understood that, as used herein, “first,” “second,” and “third,” are assigned arbitrarily and are merely intended to differentiate between two or more additives, etc., as the case may be, and does not indicate any sequence. Furthermore, it is to be understood that the mere use of the word “first” does not require that there be any “second,” and the mere use of the word “second” does not require that there be any “third,” etc.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent(s) or other documents that may be incorporated herein by reference, the definitions that are consistent with this specification should be adopted.

1. A method of treating a portion of a subterranean formation comprising:
introducing a treatment fluid into the subterranean formation, wherein the treatment fluid comprises:
a base fluid;
a first additive, wherein the first additive dissolves an iron compound to form free iron in the treatment fluid, wherein the first additive is in a concentration in the range of 0.001% to 10% volume/volume of the base fluid, and wherein the first additive scavenges hydrogen sulfide gas; and
a second additive, wherein the second additive chelates the free iron, and wherein the second additive is in a concentration in the range of 0.006% to 15% volume/volume of the base fluid,
wherein the first additive and the second additive are compatible and create a synergistic effect.

2. The method according to claim 1, wherein the first additive is an unsaturated aldehyde.

3. The method according to claim 2, wherein the unsaturated aldehyde is acrolein.

4. The method according to claim 1, wherein the second additive is a chelating agent.

5. The method according to claim 1, wherein the second additive is selected from the group consisting of ethylenediaminetetraacetic acid, hydroxyethylethylenediaminetriacetic acid, a sugar acid, and combinations thereof.

6. The method according to claim 5, wherein the sugar acid is selected from the group consisting of aldonic acids, uronic acids, aldaric acids, and combinations thereof.

7. The method according to claim 6, wherein the aldonic acid is selected from glyceric acid, xylonic acid, gluconic acid, or ascorbic acid.

8. The method according to claim 6, wherein the uronic acid is selected from glucuronic acid, galacturonic acid, or iduronic acid.

9. The method according to claim 6, wherein the aldaric acid is selected from tartaric acid, meso-galactaric acid, or D-glucaric acid.

10. The method according to claim 4, wherein the chelating agent comprises a counter cation, wherein the counter cation is an alkali metal or an alkaline earth metal.

11. The method according to claim 10, wherein the counter cation is selected from the group consisting of sodium, potassium, magnesium, calcium, strontium, cesium, and combinations thereof.

12. The method according to claim 1, wherein the first additive is in a concentration in the range of 0.01% to 10% volume/volume of the base fluid.

13. The method according to claim 1, wherein the first additive is in a concentration in the range of 100 to 100,000 parts per million of the base fluid.

14. The method according to claim 1, wherein the second additive is in a concentration in the range of 0.006% to 10% volume/volume of the base fluid.

15. The method according to claim 1, wherein the second additive is in a concentration in the range of 60 to 100,000 parts per million of the base fluid.

16. The method according to claim 1, wherein the treatment fluid remains in the subterranean formation for a desired period of time, wherein the desired period of time is a minimum amount of time such that the iron compound is dissolved, hydrogen sulfide is scavenged, and the free iron is prevented from forming a compound and reprecipitating out of the treatment fluid.

17. The method according to claim 16, wherein the desired period of time is in the range of 6 hours to 5 days.

18. A treatment fluid comprising:
a base fluid;
a first additive, wherein the first additive dissolves an iron compound to form free iron in the treatment fluid, wherein the first additive is in a concentration in the range of 0.001% to 10% volume/volume of the base fluid, and wherein the first additive scavenges hydrogen sulfide gas; and
a second additive, wherein the second additive chelates the free iron, and wherein the second additive is in a concentration in the range of 0.006% to 15% volume/volume of the base fluid,
wherein the first additive and the second additive are compatible and create a synergistic effect.

19. The treatment fluid according to claim 18, wherein the first additive is acrolein.

20. The treatment fluid according to claim 18, wherein the second additive is selected from the group consisting of ethylenediaminetetraacetic acid, hydroxyethylethylenediaminetriacetic acid, a sugar acid, and combinations thereof.
